(19) United States
(12) Patent Application Publication
(10) Pub. No.: US 2005/0139086 A1
(43) Pub. Date: Jun. 30, 2005

(54) Toaster grill

(76) Inventor: Bryan McHutchison, Kellyville (AU)

Correspondence Address: MICHAEL MOLINS;MOLINS & CO., SUITE S, LEVEL 6, 139 MACQUARIE ST, SYDNEY NSW, 2000, AU

(21) Appl. No.: 10/503,904

(22) PCT Filed: Jun. 24, 2004
(86) PCT No.: PCT/AU04/00827

(30) Foreign Application Priority Data
Jul. 2, 2003 (AU) 2003903366

(51) Int. Cl. A47J 37/08

(52) U.S. Cl. 99/389; 99/446

(57) ABSTRACT

A toaster grill having an upper and a lower cooking assembly. The upper assembly has an upper cooking surface that pivots from a central hinge. The lower cooking assembly has a lower cooking surface and one or more adjustable feet for altering the angle of the lower cooking surface. The toaster grill also has a ‘U’ shaped frame with a front handle pivoted to the lower cooking assembly at a rear mounted position. The ‘U’ shaped frame has a slider adapter that rests on one of a number of steps that are formed into the side of the lower cooking assembly, each step giving a different minimum gap between the upper and lower cooking surfaces. The toaster grill has one or more adjustable feet for altering the angle of the lower cooking surface. When retracted, the lower cooking surface is substantially horizontal; when deployed, the lower cooking surface is inclined.

### FIELD OF THE INVENTION

The invention pertains to kitchen appliances and more particularly to a toaster grill.

### BACKGROUND OF THE INVENTION

A sandwich press is an electrical kitchen appliance which comprises upper and lower heated cooking surfaces between which a sandwich can be placed so that the sandwich can be toasted. In some embodiments, the lower surface is fixed and the top surface is free to fall under the force of gravity. In other embodiments, the upper surface is free to fall but may be height adjusted to maintain a minimum gap between the top and bottom surfaces. In a sandwich press, the bottom surface is always horizontal.

A bench top grill is depicted, for example, in U.S. Pat. No. 5,606,905. Grills of this type reach higher cooking temperatures than sandwich makers. Accordingly, meat can be cooked. However cooking meat hat these temperatures produces liquids such as oils, fats and juices (together referred to in this document as “drippings”) which either run off or accumulate on the lower cooking surface. This particular device depicts an inclined lower cooking surface with grilling ribs which extend upwardly from the plate. The front portions of those ribs are curved upwardly to prevent food from sliding off the lower cooking surface. The upper grilling surface and lower grilling surface are hinged to one another only from the back of the appliance. Devices of this type do not have any way of adjusting the angle of the bottom grilling surface.

Another style of grill is depicted in the U.S. Pat. No. 6,363,835. Similarly, the cooking angle of the bottom grilling surface is not adjustable and in this type of device there is no convenient way of collecting the drippings that will run off from the food which is being grilled.

### OBJECTS AND SUMMARY OF THE INVENTION

It is an object of the present invention to provide a combination toaster grill where the angle of the lower cooking surface, with respect to the horizontal, is adjustable.

It is another object of the invention to provide a toaster grill having a top cooking surface which pivots from a central rather than a rear mounted hinge and which includes features for allowing the collection drippings from both the top and bottom cooking surfaces.

Accordingly, there is provided a toaster grill having a lower assembly which comprises a lower cooking surface and adjustable feet.

In some embodiments the feet are provided as a front (or rear) pair that each fold from a concealed to a deployed position.

In some embodiments, the device also includes a ‘U’ shaped frame which is pivoted to the rear of the lower assembly. The frame further comprises a pair of opposed and centrally located pivots which support the upper cooking assembly. The upper and lower cooking assemblies are interconnected by an electrical cord which supplies power to the upper cooking assembly.

In some embodiments the rear portions of the top and bottom cooking assemblies are interconnected by a link which establishes a maximum separation of the rear portions and also positions the rear of the top assembly so that it discharges drippings onto the bottom assembly.

### BRIEF DESCRIPTION OF THE DRAWING FIGURES

FIG. 1 is a top plan view of a toaster grill according to the teachings of the present invention;

FIG. 2 is a side elevation of the device depicted in FIG. 1;

FIG. 3 is a perspective view of the device depicted in FIGS. 1 and 2, with the top cooking assembly fully open;

FIG. 4 is a cross section of the device depicted in FIG. 2 illustrating the adjustable front foot;

FIG. 5 is another cross section of the device depicted in FIG. 4 showing the foot in the retracted position;

FIG. 6 is a perspective detail of the folding foot;

FIG. 7 (a)(b) are details of the foot showing how rubber inserts are used to achieve height differences;

FIG. 8 (a)(b) are perspective details showing the folding foot;

FIG. 9 is a perspective view of a foot, partially cross sectioned to show the details of the insert-molding;

FIG. 10 is a rear perspective view of the device depicted in FIG. 1; and

FIG. 11 is a perspective view of a pivoting foot and cavity prior to assembly; and

FIG. 12 is a side elevation showing the link.

### BEST MODE AND OTHER EMBODIMENTS OF THE INVENTION

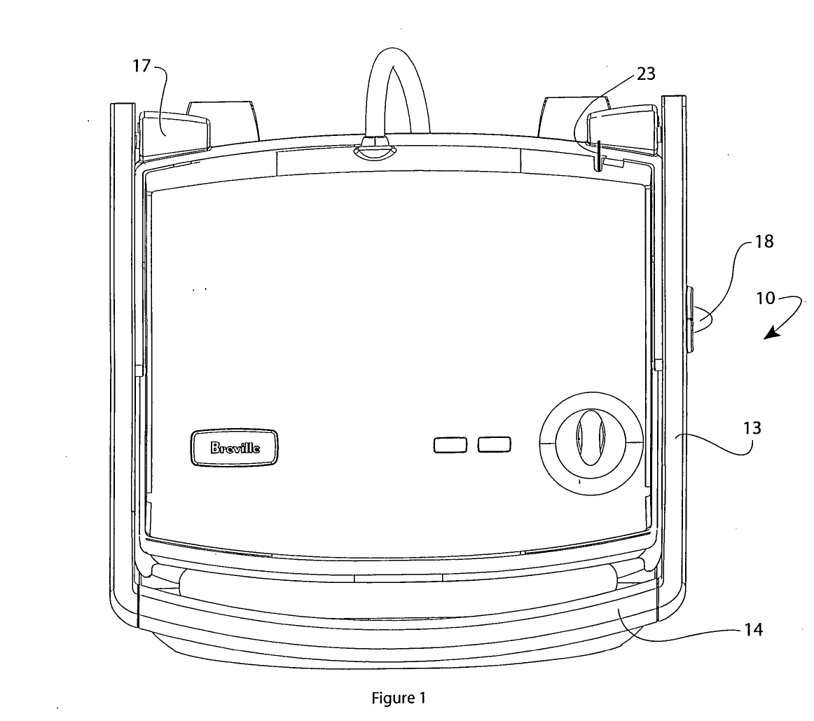

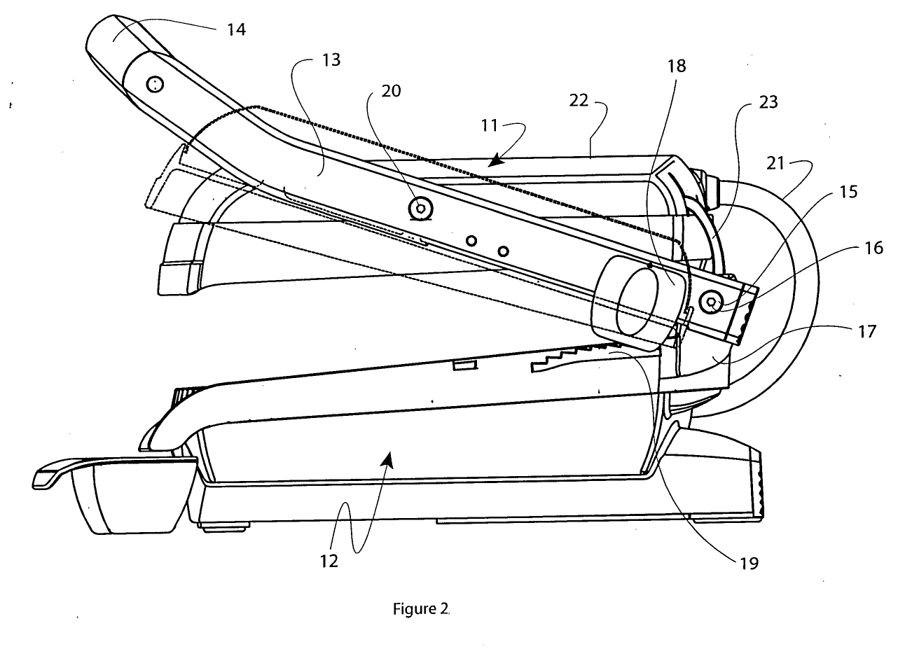

As shown in FIGS. 1 and 2, a toaster grill 10 comprises and upper cooking assembly 11 and a lower cooking assembly 12. Each assembly comprises a housing, a cooking surface and a heating element. A ‘U’ shaped frame 13 includes a front handle portion 14 and is pivoted to the lower cooking assembly 12 at rear mounted position 15. Accordingly, pivots 16 pass through the rear of the frame 15 to elbows 17 which are formed with the lower cooking assembly and which elevate the fixed pivot point 16 of the hinges above the cooking surface of the lower assembly. The device features a temperature controller and heating elements in each assembly 11, 12 which provide for average cooking temperatures of about 180 C to 230 C.

As illustrated in FIGS. 1 and 2, the ‘U’ shaped frame 13 also includes a slider 18 which is adapted to rest on any one of a seriess of steps 19 which are formed into the side of the lower cooking assembly 12. Depending upon which step 19 the slider 18 rests on, a different minimum gap between the upper and lower assemblies is established.

As depicted in FIG. 2, the upper cooking assembly 11 pivots about a pair of hinge points 20 located centrally on the sides of the frame 13 and generally between the handle 14 and the rear pivot 16.

FIG. 2 also shows an electrical cord 21 extending between the upper and lower cooking assemblies 11, 12. Cord 21 may be wrapped in a stainless steel protective coil if required. The cord 21 restrains the movement of the rear end 22 of the upper assembly when there are no other forces acting on the upper assembly. It will be understood that the presence of an irregularly shaped food item between the cooking plates will allow the upper assembly 11 to pivot and accommodate the shape of the food being cooked. The range of motion of the rear 22 of the upper cooking assembly 11 is also maintained by a link 23 which in effect limits the maximum separation between the rear 22 of the upper assembly 11 and the rear of the lower assembly 12. The link extends between the rear of the upper and lower assemblies.

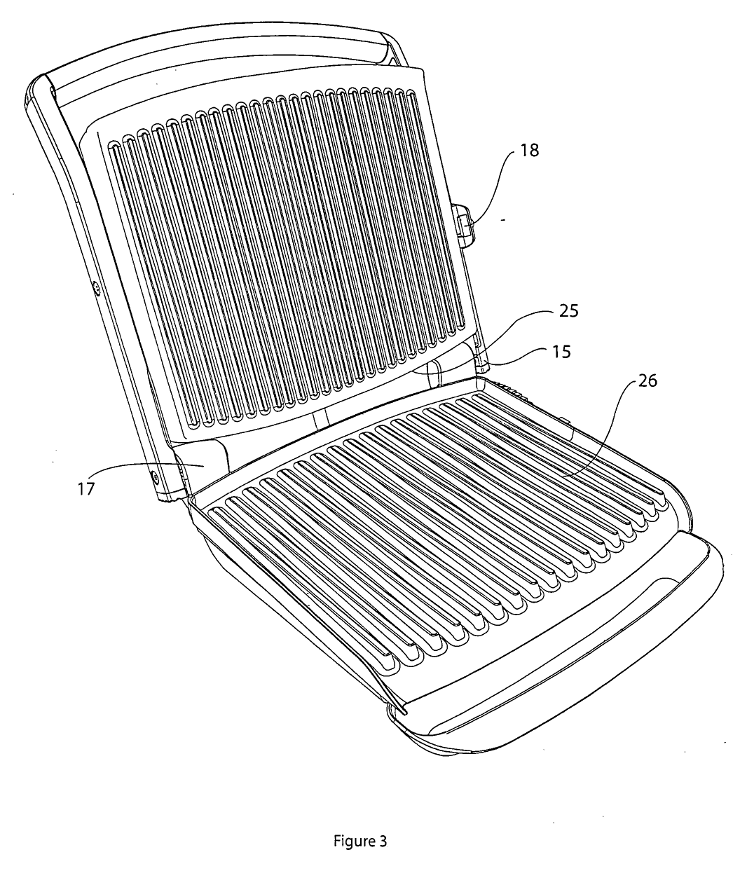

As shown in FIG. 3, the top assembly may be pivoted open to an open position which is greater than 90 degrees from the lower assembly. This position is used to load and unload the appliance with food and also permits the cooking of food with the plate in this open orientation. When in this position, the link 23 prevents the rear of the upper plate 11 from pivoting excessively and maintains the location of the rear edge 25 of the upper cooking surface in a position which is always over some portion of the lower cooking surface 26 (see FIG. 12). In this way, drippings from the upper cooking surface always fall onto the lower cooking surface 26.

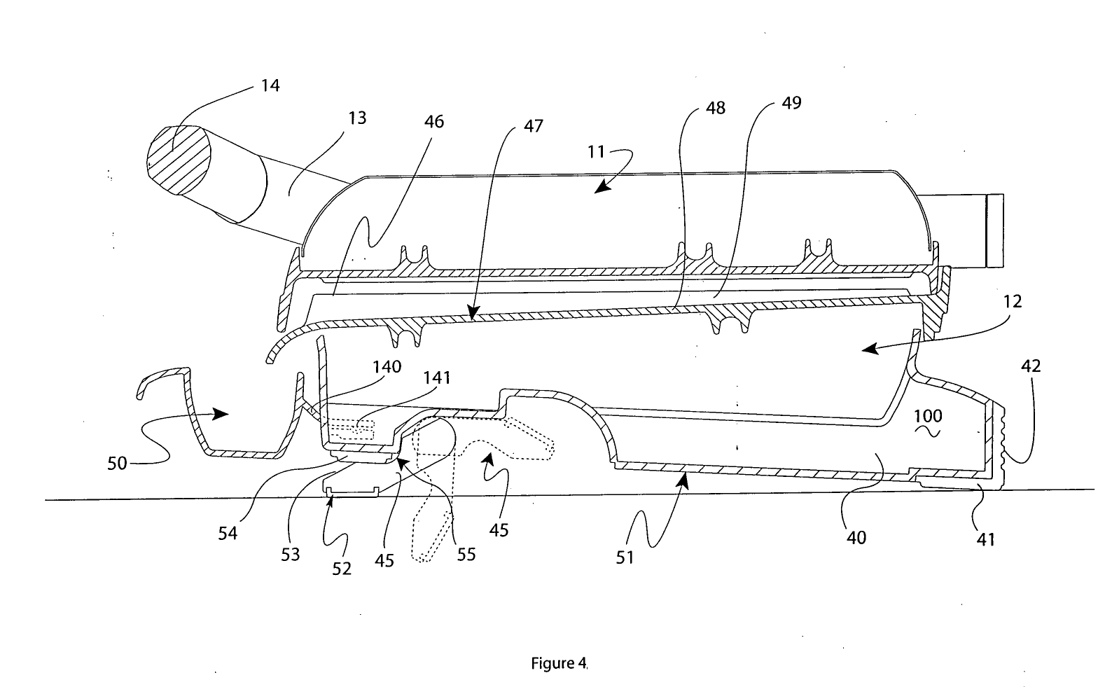

As shown in FIG. 4, the angle of the lower assembly 12 and therefore the lower cooking or grilling surface 47 is adjustable. The lower cooking assembly 12 includes a fixed rear foot 40 having rubber gripping surfaces on its bottom 41 and rear 42. The lower assembly 12 also has a pivoting front foot 45 which is capable of two distinct and stable positions. The provision of an adjustable foot 45 of this type allows the angle of the actual cooking surface 47 to be adjusted, for example, making the cooking surface flat or inclined as required. It will be observed that the device exemplified by FIG. 4 includes a lower cooking surface 47 which includes a bottom surface or cooking surface base 48 (between the ribs, if any) as well as optional cooking ribs 49. In this example, the folding foot 45 is shown in a deployed position which has the effect of elevating the front of the device. When the foot 45 is pivoted fully forward, it rests with its rubber pad 52 in contact with the ground. So that the front surface 53 of the foot 45 does not interfere with the permanent front foot 54, it includes a relief portion 55. In this orientation, the food contacting surface 46 comprising the tops of the ribs 49 is horizontal. This prevents foods such as sausages from rolling off of the lower assembly. Note that with the tops of the ribs 46 being horizontal, the base 48 of the cooking surface is inclined about 2 degrees from the horizontal. This promotes the discharge of run off and drippings into a collection trough 50. Note that the tops of the ribs 46 are flat and do not need to be curved or raised further to prevent food from falling off of the appliance.

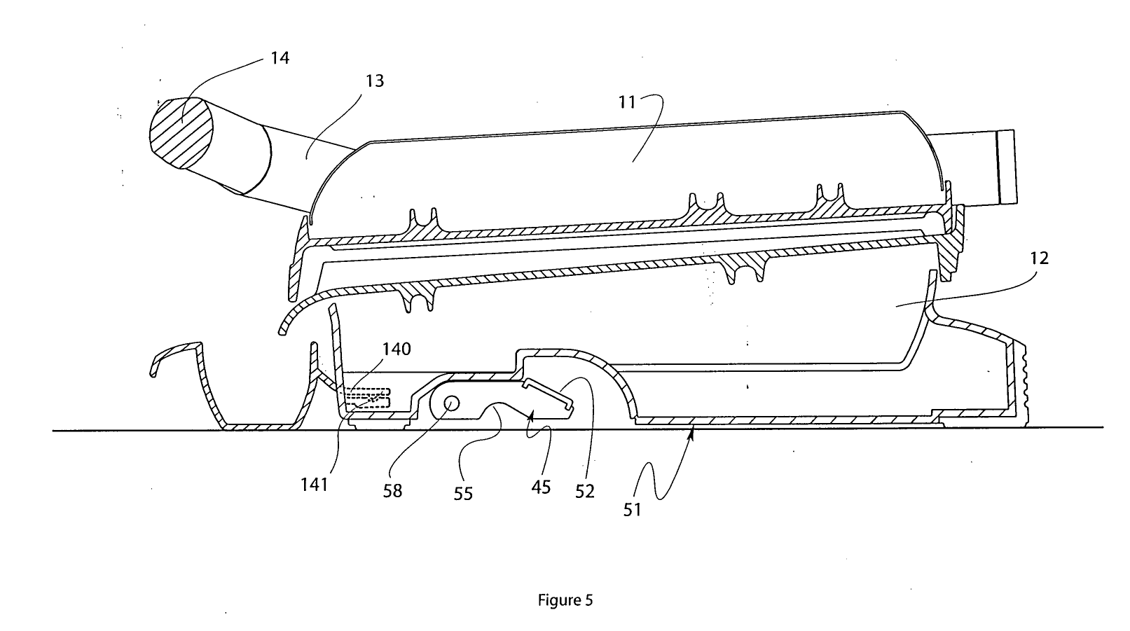

As shown in FIGS. 4 and 5, when the pivoting foot 45 is retracted, it lies entirely below the bottom surface 51 of the lower cooking assembly. In this orientation the front of the lower cooking assembly 12 rests on the pad of the permanent front foot 54.

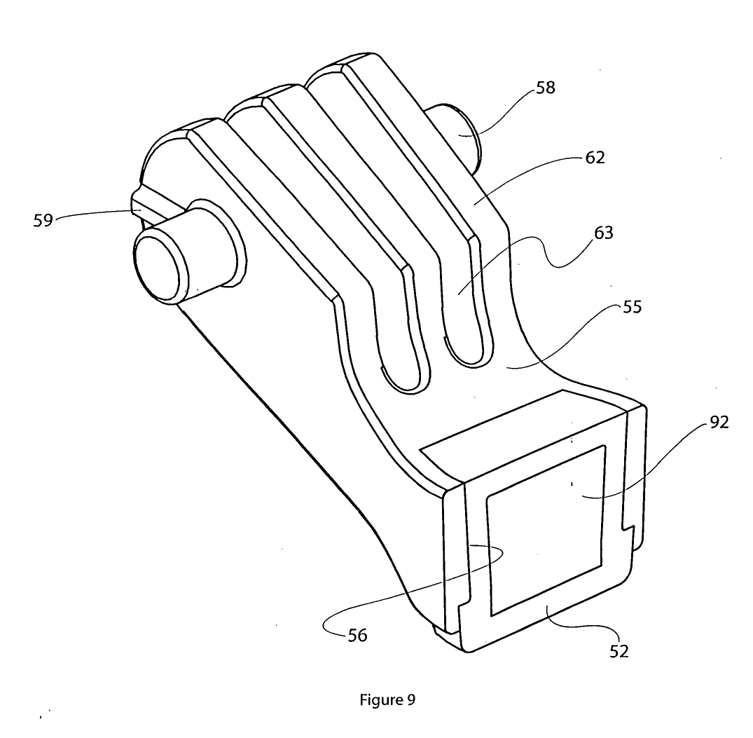

FIGS. 4 and 8 also illustrate that the drip collection tray 50 has one or more flat fingers 140 which are insertable into slots formed in the front face of the lower assembly. The fingers 140 may have raised bumps or domes 141 which engage with cooperating recesses 142 formed adjacent to the undersurface of the lower assembly (see FIG. 8). This prevents the tray 140 from inadvertent movement. Note, from FIG. 4, that the tray is fully supported by the lower assembly and raised above the ground when the forward adjustable feet 45 are extended. FIG. 5 shows that when the feet 45 are folded away, the tray 50 can rest on the bench surface.

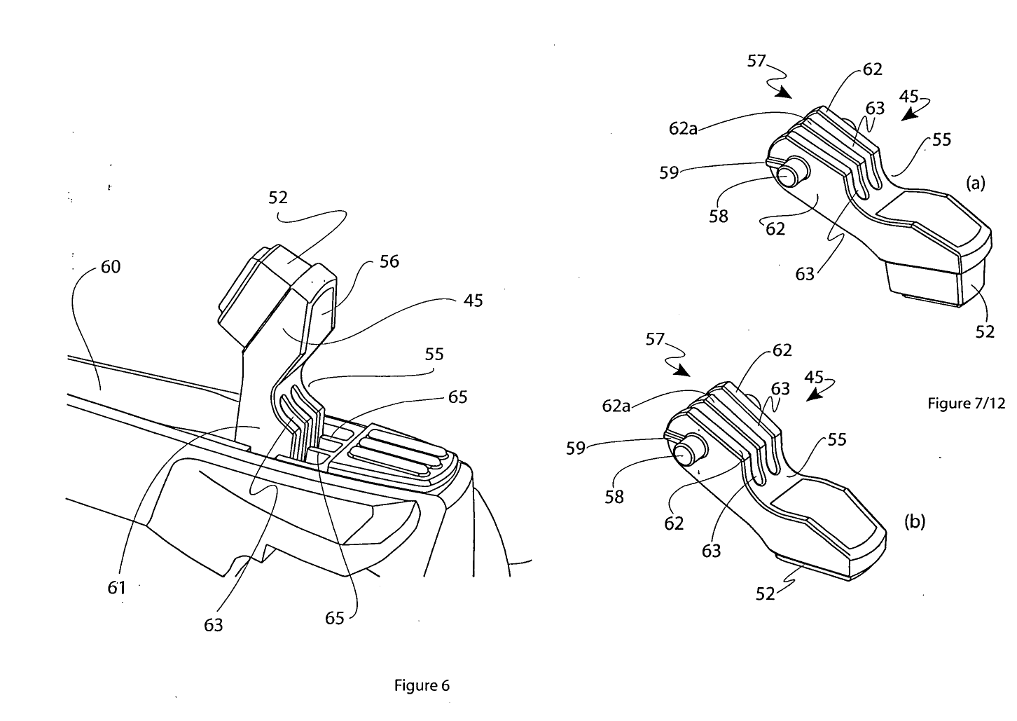

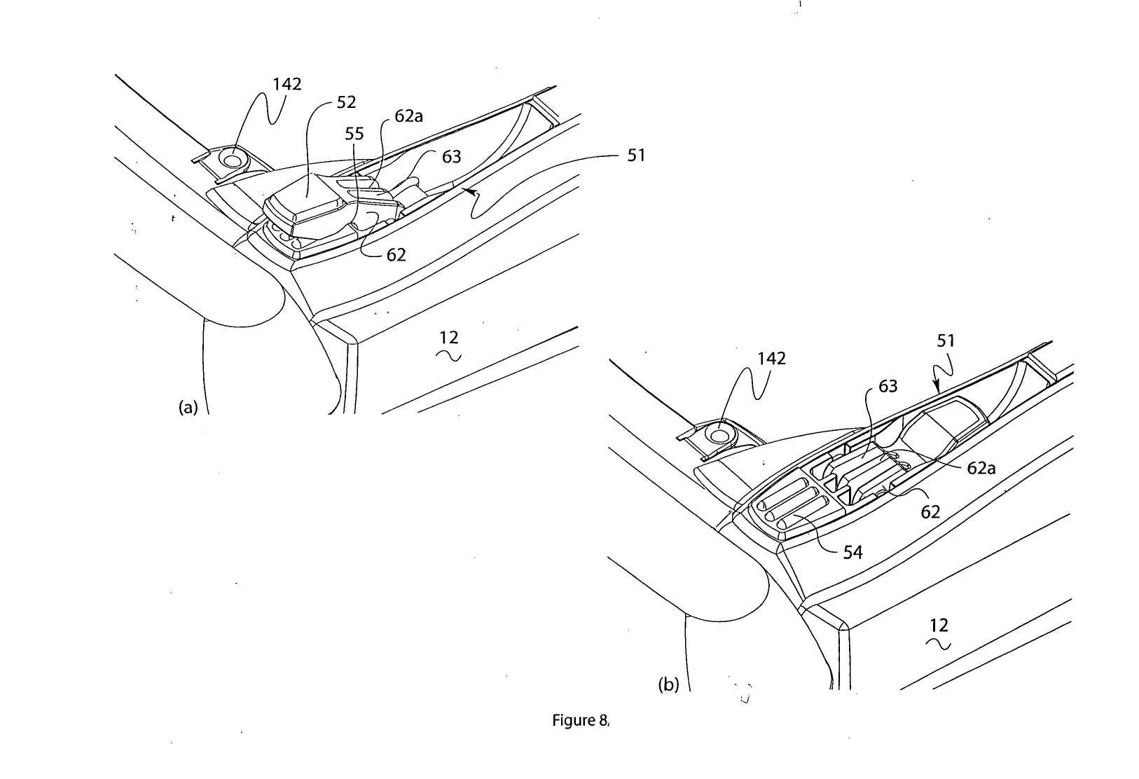

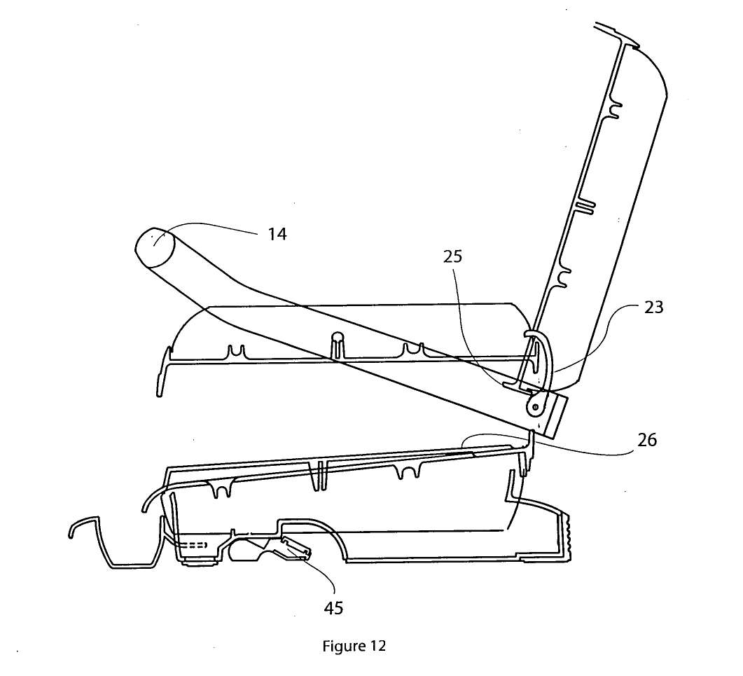

As shown in FIGS. 6-8 and 11, the foot 45 includes features which make it both easy to assemble, robust in its use and flexible in its application. As shown in those figures, the foot 45 is in the form of a pivoting leg having a front recess or opening 56, a doubly slotted rear portion 57 and the mid-body relief portion 55. The slotted rear portion 57 forms two external ears 62 and an internal ear 62a. The external ears 62 each have an outwardly facing horizontal pivot 58. The pivot 58 includes a retaining finger 59. As shown in FIGS. 6 and 11, the cavity 60 which retains the pivoting foot 45 includes a pair of opposed slots 61 in its side walls 62. The slots have internal ramps 61a forming a detent mechanism for retaining the pivots 58. These slots 61 accommodate the pivots 58 when they are inserted, but to ride over the ramps 61a, the pivots 58 must move closer to one another. This movement of the external ears 62 and pivots 58 is possible because the slots 63 allow the ears 62 to flex toward each other. Thus, when the foot 45 is inserted into the well 60 past the ramps, the side plates 62 flex, then snap back into position, fixing them in the slots 61 in a journal 61b located past the ramps 61a. When the foot is in it's extended position (see FIGS. 4 and 8 (a)) the slots 63 interdigitate with ribs 65 in the cavity 60 and thus it is not possible for the ears 62 to move toward one another as would be required for removal of the foot. In this way, the foot is locked in place when it is in the extended position. When the foot is in a fully retracted position as shown in FIGS. 5 and 8 (b), the retaining finger 59 is retained by a web 61c in the area adjacent to the slot 61. Note that the cavity is long enough (see FIGS. 8a and 8b) to accommodate a finger for the purpose of removing the foot from the retracted position.

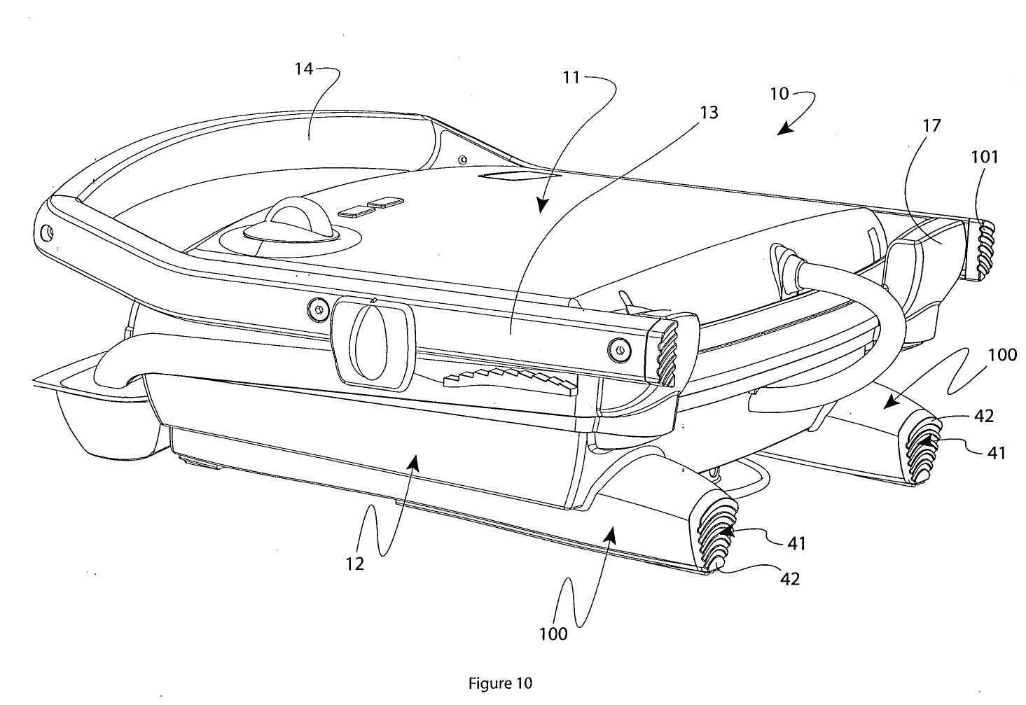

As shown in FIG. 9, the foot's opening or recess 56 may be filled or insert molded with rubber pads 52 of various pad height dimensions. The cavity 56 features an internal shoulder 91 which assists the foot in retaining the pad 52 under compression loads. A portion of the foot body 92 also intrudes at least partially into the opening 56. This intrusion also helps in retaining the rubber pad 52. It will be appreciated that this arrangement allows rubber pads of different dimensions to be molded into a single foot thus minimising manufacturing costs and providing flexibly required to manufacture different models while using the same foot.

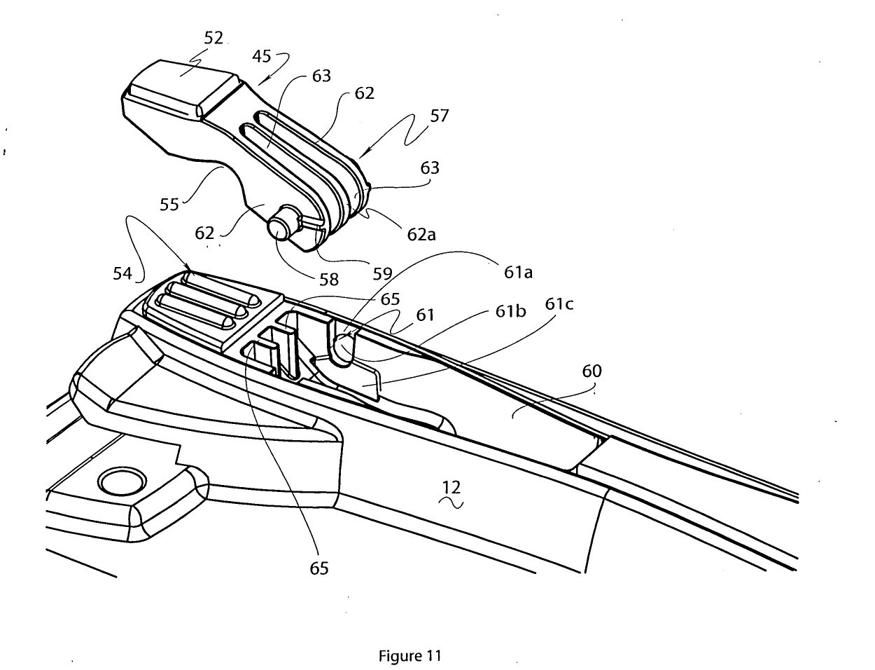

As shown in FIGS. 4 and 10, the toaster grill 10 of the present invention has a lower cooking assembly which includes permanently mounted rear stabilising feet 100. These stabilising feet 100 have rubberised surfaces 41, 41 which allow the device to be positioned in any one of a number of different cooking positions as well as in a vertical orientation for storage. When in the vertical orientation, the axial pads 42 make contact with the ground at the same point that the rubberized bottoms 101 of the frame 13. This allows the device to be stored in a convenient upright orientation.

1. A toaster grill, the grill comprising an upper cooking surface, and a lower cooking assembly having a lower cooking surface wherein:
the lower cooking assembly is tilt adjustable by at least one foot, the foot having a retracted position and a deployed position such that the lower cooking surface is either horizontal or inclined depending on the position of the foot.

2. The toaster grill of claim 1 wherein:
the adjustable foot is a folding foot comprising:
a pivoting leg having a slotted pivot portion.

3. The toaster grill of claim 2 wherein:
the foot further comprises an internal shoulder for retaining a rubber pad.

4. The toaster grill of claim 2 wherein:
the slotted pivot portion forms two external ears, the external ears each having an outwardly facing horizontal pivot.

5. The toaster grill of claim 1, wherein:
the foot is inserted into a cavity in the lower cooking assembly, the cavity having a pair of opposed slots forming a detent mechanism for retaining the horizontal pivots.

6. The toaster grill of claim 5 wherein:
the external ears are flexible and snap into position when inserted into the cavity.

7. The toaster grill of claim 1 wherein:
the foot is locked into place when in the retracted position by a retaining finger.

8. The toaster grill of claim 1 wherein:
the foot lies flush with or below the bottom surface of the lower cooking assembly when in the retracted position.

9. A toaster grill having a lower cooking assembly and an upper cooking assembly, wherein:
the upper cooking assembly comprises an upper cooking surface;
the upper assembly being hinged to the lower cooking assembly;
the lower cooking assembly further comprising a lower cooking surface having ribs, the ribs each having a top portion that extends above a base surface;
the top portions of the ribs being inclined with respect to the base surface.

10. (canceled)

11. The cooking surface of claim 9 wherein:
the cooking ribs are arranged substantially perpendicular to a removable drip collection tray.

12. The cooking surface of claim 9 wherein:
the upper cooking assembly comprises an upper cooking surface that is pivotally attached to a frame.

13. The cooking surface of claim 9 wherein:
an inclined angle of the ribs with respect to base surface is approximately 2 degrees.

14. A toaster grill comprising:
a lower cooking assembly having a lower cooking surface, and one or more adjustable feet;
an upper cooking assembly having a pivoting upper cooking surface and a handle; and
a drippings collection tray.

15. The toaster grill of claim 14 wherein:
the upper cooking assembly pivots about a pair of hinge points located centrally on the sides of the toaster grill generally between the handle and a rear pivot point.

16. The toaster grill of claim 14, the upper cooking assembly further comprising:
a ‘U’ shaped frame having a front handle portion that is pivoted to the lower cooking assembly at a rear mounted position wherein:
the ‘U’ shaped frame includes an adjuster adapted to rest on a portion of the lower cooking assembly, providing an adjustment in the minimum gap between the upper and lower cooking surfaces.

17. The toaster grill of claim 14 wherein:
the upper and lower cooking assemblies are interconnected by a link that establishes a maximum separation of the rear portions of the upper and lower cooking surfaces, and positions the rear of the top cooking assembly so that the top cooking surface discharges drippings onto the bottom cooking surface.

18. The toaster grill of claim 14 wherein:
the adjustable feet have a retracted position and a deployed position such that the lower cooking surface is either inclined or not depending on the position of the feet.

19. The toaster grill of claim 14 wherein:
the adjustable feet have rubberised pads.

20. The toaster grill of claim 14 wherein:
the adjustable feet are folding feet comprising a pivoting leg having a slotted portion, the slotted portion forms two external ears, the external ears each having an outwardly facing horizontal pivot.

21. The toaster grill of claim 18 wherein:
the feet are each inserted into a cavity in the lower cooking assembly, the cavity having a pair of opposed slots forming a detent mechanism for retaining the horizontal pivots.
